(19) United States
(12) Patent Application Publication
(10) Pub. No.: US 2007/0112952 A1
(43) Pub. Date: May 17, 2007

(54) System and method for synchronized startup of document processing services

(75) Inventors: Ajit Sodhi, Irvine, CA (US); Man Mohan Garg, Cerritos, CA (US); Andrey Savov, Fullerton, CA (US)

Correspondence Address: TUCKER, ELLIS & WEST LLP, 1150 HUNTINGTON BUILDING, 925 EUCLID AVENUE, CLEVELAND, OH, 44115-1414, US

(73) Assignee: Kabushiki Kaisha Toshiba and Toshiba Tec Kabushiki Kaisha

(21) Appl. No.: 11/273,201

(22) Filed: Nov. 14, 2005

(51) Int. Cl. G06F 15/173

(52) U.S. Cl. 709/224; 709/223

(57) ABSTRACT

A system and method for monitoring the startup process for a plurality of document processing services to determine if each of the process has started properly. A service startup manager initiates the startup and monitors a plurality of processes associated with a document processing device. The service startup manager then awaits the receipt of a periodic beacon, originated by each process, indicating the normal startup and operation of the process in question. When the periodic beacon associated with a process is not received by the startup manager within a predetermined period of time, the service startup manager transmits a shutdown command to the process and waits for the process to terminate. When a shutdown does not occur, the service startup manager forcibly terminates the process. The service startup manager then restarts the process. Once the process becomes available again, the service startup manager notifies each process registered with the manager of the availability of process to receive notification of the availability of process.

### BACKGROUND OF THE INVENTION

This invention is directed to a system and method for synchronized startup of document processing services. In particular, this invention is directed to a system and method for monitoring the startup process for a plurality of document processing services to determine if each of the processes has started properly.

Document processing devices, such as multifunctional peripheral devices, generally comprise a service startup manager or controller which is responsible for starting and monitoring all the document processing services associated with the multifunctional peripheral device. The service startup manager must determine the proper startup sequence for the document processing services. The startup sequence of the document processing service is determined based on the startup parameters and other settings, such as service dependencies, for all of the services to be started.

If a document processing service fails to start or quits functioning unexpectedly, the service startup manager must then restart the failed service. However, if the service that fails is one upon which other services require to be functioning in order for such dependent services to start and function properly, all dependent service must be restarted for proper system function. This results in a delay in the availability of the document processing services. In addition, each time a service is added or removed from the multifunctional peripheral device, the service dependencies associated with such service must be updated accordingly. Updating the service dependency data is often a complex process, and must be performed very carefully to ensure that all dependencies are modified correctly for proper system startup. Such process can be quite time consuming and prone to error.

A further problem encountered by the service startup manager is that the operation of a service is often monitored by the presence of a processing identification associated with such service. A service in a non-operational state or a zombie process state would result in the service having a processing identification, but such a service would not available for processing. Therefore, there is a need for a system and method for monitoring the startup process for a plurality of document processing services to determine if each of the processes has started properly and which allows services to start in any order, and not based on complex dependencies.

The subject invention overcomes the afore-noted problems associated with starting a plurality of document processing services and provides a system and method for synchronizing the startup of such document processing services.

### SUMMARY OF THE INVENTION

In accordance with the present invention, there is provided a system and method for synchronized startup of document processing services.

Further, in accordance with the present invention, there is provided a system and method for monitoring the startup process for a plurality of document processing services to determine if each of the process has started properly.

Still further, in accordance with the present invention, there is provided a system and method for synchronizing the startup of document processing services which allows the document processing services to start in any order, and not based on complex dependencies.

Still further, in accordance with the present invention, there is provided a system for synchronized startup of document processing services. The system comprises startup means adapted for commencing startup of a plurality of associated document processing services and means adapted for receiving from each of the plurality of document processing services a periodic status signal from each of the associated document processing services. The system further comprises monitoring means adapted for monitoring an aberration in each period status signal and means adapted for selectively aborting a startup of at least one of the associated document processing services in accordance with an output of the monitoring means.

Still further, in accordance with the present invention, there is provided a method for synchronized startup of document processing services. The method comprises the steps of commencing startup of a plurality of associated document processing services, receiving from each of the plurality of document processing services a periodic status signal from each of the associated document processing services, and monitoring an aberration in each period status signal. The method further comprises selectively aborting a startup of at least one of the associated document processing services in accordance with an output of the monitoring means.

Still other objects and aspects of the present invention will become readily apparent to those skilled in this art from the following description wherein there is shown and described a preferred embodiment of this invention, simply by way of illustration of one of the best modes suited for to carry out the invention. As it will be realized, the invention is capable of other different embodiments and its several details are capable of modifications in various obvious aspects all without from the invention. Accordingly, the drawing and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a block diagram of the system according to the present invention;

FIG. 2 is a flowchart illustrating a method for synchronized startup of document processing services in accordance with the present invention.

### DETAILED DESCRIPTION OF THE PREFERRED EMBODIMENT

This invention is directed to a system and method for synchronous startup of document processing operations. In particular, the present invention is directed to a system and method for monitoring the startup process for a plurality of document processing services to determine if each of the process has started properly. Preferably, the document processing device is a multifunctional peripheral device, capable of providing scanning, copying, facsimile, printing, document management, document storage, electronic mail, and other functions to a user.

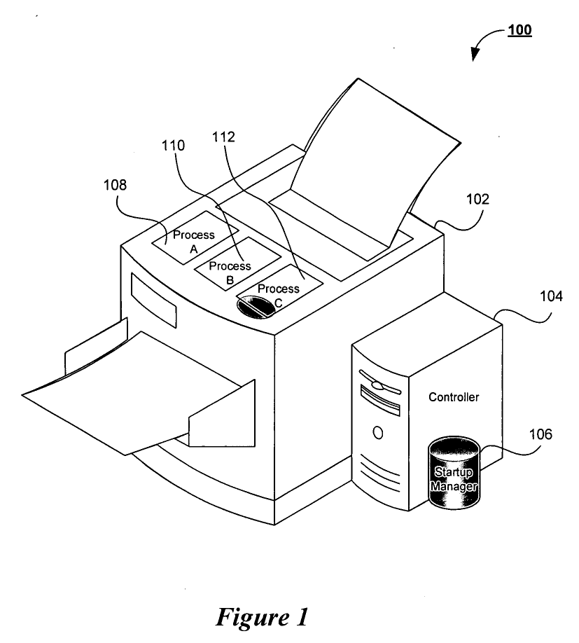

Referring now to FIG. 1, there is shown a block diagram illustrating a system 100 in accordance with the present invention. It will be appreciated by those skilled in the art the document processing device 102 is advantageously represented in FIG. 1 as a multifunction peripheral device, suitably adapted to provide a variety of document processing services, such as, for example and without limitation, scanning, copying, facsimile, printing, and the like. Suitable commercially available image generating devices include, but are not limited to, the Toshiba e-Studio Series Controller. In one embodiment, the document processing device 104 is suitably equipped to receive a plurality of portable storage media, including without limitation, Firewire drive, USB drive, SD, MMC, XD, Compact Flash, Memory Stick, and the like.

The system 100 further includes a controller 104 in data communication with the document processing device 102. It will be understood by those skilled in the art that the controller 104 is any hardware, software, or combination thereof, suitably adapted to facilitate the control of the document processing device 102. It will further be appreciated by those skilled in the art that such control is advantageously exercised over various hardware and software components of the document processing device 102, including, for example and without limitation, modems, network interface components, printer engines, copier components, facsimile components, optical character recognition, and the like. The controller 104 includes a service startup manager 106 suitably adapted to initialize and monitor all service and process components that comprise the controller 104, including, without limitation, core processes, infrastructure processes, higher-level processes, and the like.

As will be understood by those skilled in the art, infrastructure processes are basic processes that are customarily initialized first. Multiple other processes often require that these basic processes be in operation before being initialized. Suitable infrastructure processes include, but are not limited to, pre-startup processes, which prepare the run-time environment, a messaging daemon process, which enables other processes to communicate with each other via message exchange, and the like. The skilled artisan will further appreciate that core processes are also basic in nature, however the core processes typically require one or more infrastructure processes to be in operation prior to their initialization. For example and without limitation, suitable core processes include a job manager, which manages document processing request workflows, a raster image processor manager, which renders a print data stream into a printer specific image format, an engine transport manager, which enables the data transfer between the controller 104 and the document processing device 102, and the like. Those skilled in the art will understand that higher-level processes those document processing services, which require the prior activation of one or more infrastructure processes and/or one or more core processes. Such higher-level processes include, for example and without limitation, TWAIN, a line printer daemon, a parallel print service, and the like. It will be appreciated by those skilled in the art that TWAIN enables the retrieval of images scanned by the document processing device 102 from network connected clients, a line printer daemon process is suitably adapted to accept document processing requests submitted using a line printer protocol from network clients, and a parallel print process is suitably adapted to accept document processing requests received from a client directly connected via a parallel port interface.

The skilled artisan will appreciate that the various components, or services, are referred to generally herein as processes, illustrated in FIG. 1 as process A 108, process B 110, and process C 112. It will be understood by those skilled in the art that a greater or lesser number of processes are equally capable of being controlled by the service startup manger 106 in accordance with the present invention and the use of three processes is for example purposes only. In accordance with the present invention, the service startup manager 106 is suitably capable of initiating the services in a priority order, i.e., core processes, then infrastructure, then higher-level, varying such startup based upon the various dependencies among the processes as will be understood by those skilled in the art. In an alternate embodiment of the present invention, the service startup manager 106 is equally capable of initiating the processes in any order such that dependent processes are initialized prior to the initialization of processes from which they depend. Upon launching of each process 108, 110, and 112, by the service startup manager 106, the process 108, 110, 112 initializes its instance and broadcasts its availability. When the process 108, 110, 112, has a dependency on one or more other services, the process 108, 110, 112, advantageously registers with the service startup manager 106 so as to receive a notification, generated upon the successful startup of the one or more other services. Once all dependent services associated with the process 108, 110, or 112, become available, the process 108, 110, or 112, announces its availability, i.e., notifies the service startup manager 106 that it is available for operations.

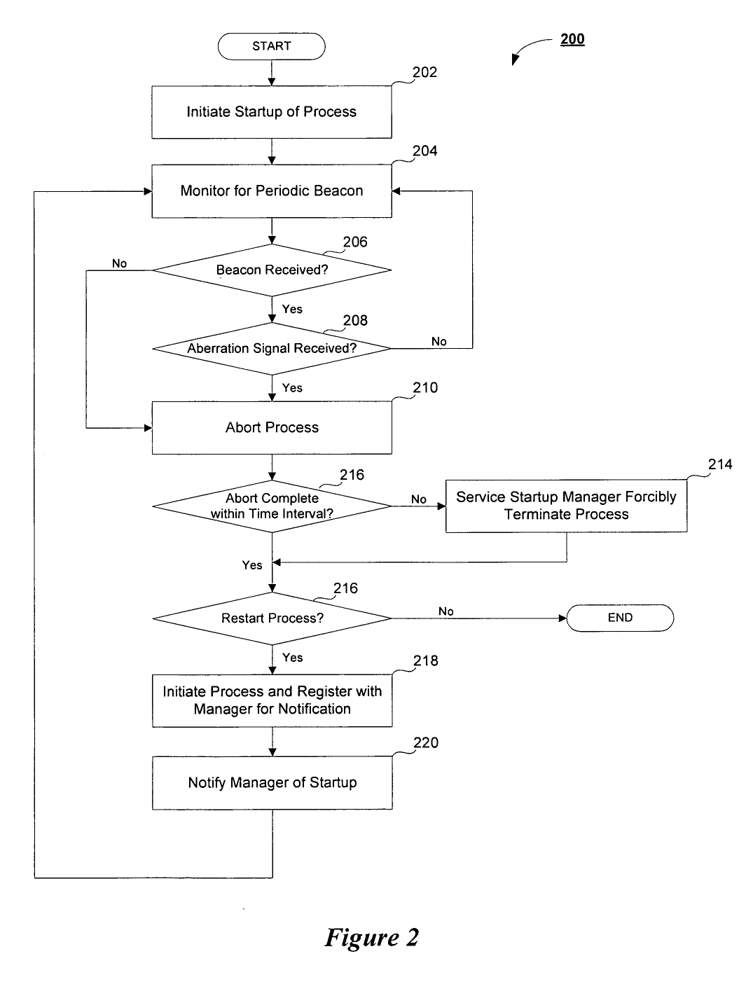

In a preferred embodiment of the present invention, each process 108, 110, 112 is capable of transmitting a periodic beacon, indicating the normal startup and operation of the process in question. More preferably, a periodic beacon is generated by the core thread of each process 108, 110, and 112. In accordance with one aspect of the present invention, the processes are suitably adapted to transmit an aberration signal to the service startup manager 106, indicating some error in the initialization of the process. The service startup manager 106 suitably monitors the transmissions of the periodic beacons from the processes 108, 110, and 112. When the periodic beacon associated with a process, for example, process A 108, is not received by the startup manager 106 within a predetermined period of time, the service startup manager 106 transmits a shutdown command to the process A 108 and waits for process A 108 to shutdown. When a shutdown does not occur in accordance with the transmitted command, the service startup manager 106 is suitably adapted to forcibly terminate the process A 108. The service startup manager 106 then restarts the process A 108. Once process A 108 becomes available again, the service startup manager 106 notifies each process registered with the manager 106 of the availability of process A 108 those processes dependent upon process A 108 for operation. The dependent processes advantageously adjust their respective states to incorporate the restart of process A 108. The foregoing system will better be understood in conjunction with the flowchart illustrated in FIG. 2, discussed below.

Turning now to FIG. 2, there is shown a flowchart 200 illustrating a method for synchronized startup in accordance with the present invention. As shown in FIG. 2, the method begins at step 202 with the initiation of the startup of the document processing services of the document processing device 102. It will be appreciated by those skilled in the art that the startup is capable of being implemented as a predetermined sequence of processes, wherein processes that depend upon other processes are initiated only after those other processes have been started. In the preferred embodiment, processes are initialized irrespective of dependencies, such that a service that has dependencies advantageously registers with the service startup manager 106 at the time of its initialization to receive notification that processes upon which it depends are active. Upon the receipt of such notification, the process informs the service startup manager that is now active and ready for further operations. At step 204, the services startup manager 106 monitors each process for the return of a periodic signal. In accordance with the present invention, each process is suitably adapted to generate a periodic signal signifying that the process is starting normally. Preferably, the core thread of each process generates a periodic beacon, which is transmitted to the service startup manager 106, indicating the proper functioning of the process. More preferably, the process does not transmit a beacon until it has received an indication from the service startup manager 106 that all its dependencies are active as well. A determination is then made at step 206 whether a signal has been received. In accordance with on aspect of the present invention, the service startup manager 106 advantageously waits a predetermined period of time between receipt of beacons before determining that a beacon has not been received. Thus, a negative determination is made at step 206 when a beacon signal has not been received by the service startup manager 106 within a predetermined time interval. Flow then proceeds to step 210, whereupon the process which failed to transmit the beacon is terminated.

When it is determined at step 206 that a signal has been received from the process, flow proceeds to step 208, wherein a determination is made whether the signal received indicates an aberration of the process. When the signal does not indicate an aberration, flow returns to step 204, wherein the service startup manager 106 monitors for the receipt of the periodic beacon. When the signal received by the service startup manager 106 is determined to indicate the presence of an aberration, flow proceeds to step 210, wherein the process, from which the aberration signal originated, is terminated. Flow then proceeds from step 210 to step 212, wherein a determination is made whether the process has aborted within a predetermined period of time. It will be understood by those skilled in the art that the determination of step 212 enables the service startup manager 106 to ascertain whether or not the process is non-responsive. When the process has terminated in accordance with the termination instructions sent by the service startup manager 106 within the allowed timeframe, flow proceeds to step 216, wherein a determination is made whether to restart the process. When no restart of the terminated process is required, the operations terminate with respect to that process.

Returning to step 212, when the process has failed to terminate within the designated timeframe, flow proceeds to step 214, wherein the service startup manger 106 forcibly terminates the offending process via any suitable means. Operations then proceed to step 216, wherein a determination is made whether to restart the aborted process. When restart is not required or not desired, the operations of the service startup manager 106 with respect to the aborted process terminates. When restart of the process is required or desired at step 216, flow proceeds to step 218, whereupon the aborted process is initialized and registers with the service startup manager 106. In one aspect of the present invention, the registration with the service startup manager 106 functions to enable the re-initialized process to receive notification of the availability of any dependent processes. A notification message is then generated at step 220 and transmitted to those processes registered with the service startup manager 106 to receive status information regarding the aborted process. Such registered processes include, but are not limited to, those processes which require the aborted process to be in operation to properly function. The skilled artisan will appreciate that in accordance with the present invention, any processes upon which the aborted process requires to be in operation are advantageously initialized, unless those processes are already in operation at the time of termination of the aborted process. Those skilled in the art will further appreciate that following notification of the availability of the re-initialized process, the core thread of the process then begins the transmission of the periodic beacon indicating the normal functioning of the re-initialized process. Flow then returns to step 204, whereupon the service startup manager 106 monitors the process for a periodic beacon indicating proper operation of the process. It will be appreciated by those skilled in the art that the foregoing method is suitably capable of initiating a process without requiring that those processes, which require the aborted process to be in operation, be re-initialized as well.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A system for synchronized startup of document processing services comprising:
startup means adapted for commencing startup of a plurality of associated document processing services;
means adapted for receiving from each of the plurality of document processing services a periodic status signal from each of the associated document processing services;
monitoring means adapted for monitoring an aberration in each period status signal; and
means adapted for selectively aborting a startup of at least one of the associated document processing services in accordance with an output of the monitoring means.

2. The system for synchronized startup of document processing services of claim 1 further comprising restart means adapted for restarting an aborted document processing service.

3. The system for synchronized startup of document processing services of claim 1 wherein the monitoring means includes means adapted for detecting absence of a periodic test signal after a selected interval.

4. The system for synchronized startup of document processing services of claim 1 wherein the startup means includes means adapted for commencing startup of the plurality of processing services in a selected sequence.

5. The system for synchronized startup of document processing services of claim 2 wherein the restart means includes means adapted for selectively restarting at least a second one of the plurality of associated services that is dependent upon an aborted startup of another processing service.

6. The system for synchronized startup of document processing services of claim 2 further comprising notification means adapted for generating a notification upon the restart of an aborted document processing service.

7. A method for synchronized startup of document processing services comprising the steps of:
commencing startup of a plurality of associated document processing services;
receiving from each of the plurality of document processing services a periodic status signal from each of the associated document processing services;
monitoring an aberration in each period status signal; and
selectively aborting a startup of at least one of the associated document processing services in accordance with an output of the monitoring means.

8. The method for synchronized startup of document processing services of claim 7 further comprising the step of restarting an aborted document processing service.

9. The method for synchronized startup of document processing services of claim 7 wherein the monitoring step further comprising detecting absence of a periodic test signal after a selected interval.

10. The method for synchronized startup of document processing services of claim 7 wherein the startup step further comprises the step of commencing startup of the plurality of processing services in a selected sequence.

11. The method for synchronized startup of document processing services of claim 8 wherein the restart step further comprises the step of selectively restarting at least a second one of the plurality of associated services that is dependent upon an aborted startup of another processing service.

12. The method for synchronized startup of document processing services of claim 8 further comprising the step of generating a notification upon the restart of an aborted document processing service.

13. A computer-readable medium of instructions having computer-readable instructions stored thereon for synchronized startup of document processing services comprising:
instructions for commencing startup of a plurality of associated document processing services;
instructions for receiving from each of the plurality of document processing services a periodic status signal from each of the associated document processing services;
instructions for monitoring an aberration in each period status signal; and
instructions for selectively aborting a startup of at least one of the associated document processing services in accordance with an output of the monitoring means.

14. The computer-readable medium of instructions having computer-readable instructions stored thereon for synchronized startup of document processing services of claim 13 further instructions for restarting an aborted document processing service.

15. The computer-readable medium of instructions having computer-readable instructions stored thereon for synchronized startup of document processing services of claim 13 wherein instructions for monitoring further comprise instructions for detecting absence of a periodic test signal after a selected interval.

16. The computer-readable medium of instructions having computer-readable instructions stored thereon for synchronized startup of document processing services of claim 13 wherein the instructions for start up further comprise instructions for commencing startup of the plurality of processing services in a selected sequence.

17. The computer-readable medium of instructions having computer-readable instructions stored thereon for synchronized startup of document processing services of claim 14 wherein the restart step further comprises selectively restarting at least a second one of the plurality of associated services that is dependent upon an aborted startup of another processing service.

18. The computer-readable medium of instructions having computer-readable instructions stored thereon for synchronized startup of document processing services of claim 14 further comprising the step of generating a notification upon the restart of an aborted document processing service.

19. A computer-implemented method for synchronized startup of document processing services comprising the steps of:
commencing startup of a plurality of associated document processing services;
receiving from each of the plurality of document processing services a periodic status signal from each of the associated document processing services;
monitoring an aberration in each period status signal; and
selectively aborting a startup of at least one of the associated document processing services in accordance with an output of the monitoring means.

20. The computer-implemented method for synchronized startup of document processing services of claim 19 further comprising the step of restarting an aborted document processing service.

21. The computer-implemented method for synchronized startup of document processing services of claim 19 wherein the monitoring step further comprising detecting absence of a periodic test signal after a selected interval.

22. The computer-implemented method for synchronized startup of document processing services of claim 19 wherein the startup step further comprises the step of commencing startup of the plurality of processing services in a selected sequence.

23. The computer-implemented method for synchronized startup of document processing services of claim 20 wherein the restart step further comprises the step of selectively restarting at least a second one of the plurality of associated services that is dependent upon an aborted startup of another processing service.

24. The computer-implemented method for synchronized startup of document processing services of claim 20 further comprising the step of generating a notification upon the restart of an aborted document processing service.
